(19) United States
(12) Patent Application Publication
(10) Pub. No.: US 2025/0162675 A1
(43) Pub. Date: May 22, 2025

(54) SHARED ELECTRIC BIKE WITH INTEGRATED FRAME AND LAMPS

(71) Applicant: VEORIDE INC., Chicago, IL (US)

(72) Inventor: Yanke TAN, Chicago, IL (US)

(21) Appl. No.: 18/403,384

(22) Filed: Jan. 3, 2024

(30) Foreign Application Priority Data
Nov. 16, 2023 (CN) 2023231101037

(51) Int. Cl. B62J 6/04; B62H 1/02; B62J 15/00; B62J 43/28

(52) U.S. Cl. CPC B62J 6/04; B62H 1/02; B62J 15/00; B62J 43/28

(57) ABSTRACT

Provided is a shared electric bike with integrated frame and lamps, which comprises a frame comprising a support tube, a handle connected at an end of the support tube, a first frame tube securely connected to the support tube, and a second frame tube, wherein a front lamp is embedded in one end of the first frame tube, the other end of the first frame tube is securely connected to one end of the second frame tube, and the other end of the second frame tube is securely connected to a seat tube, and wherein a rear lamp is embedded in an end of the seat tube; a set of wheels; and a battery. The shared electric bike with integrated frame and lamps addresses issues related to the susceptibility of light holders to damage, affecting illumination, and the potential risk of lamp theft.

### CROSS-REFERENCE TO RELATED APPLICATIONS

This application claims priority under 35 U.S.C. § 119(a) to Chinese Patent Application No. 202323110103.7, filed on Nov. 16, 2023, which is hereby incorporated by reference herein in its entirety.

### FIELD

The present disclosure relates to the field of shared electric bikes, in particular relates to a shared electric bike with integrated frame and lamps.

### BACKGROUND

With the widespread recognition of the concept of the sharing economy, shared electric bikes have emerged as a new means of transportation. However, due to their sharing characteristics, shared electric bikes face certain shortcomings. Most existing shared electric bikes have front and rear lamps mounted on the frame through lamp holders. However, these components are susceptible to damage, which can compromise illumination, and may even pose a risk of lamp theft. Therefore, there is a need to provide a solution to address the technical problem.

### SUMMARY

In order to overcome the shortcomings of the existing technology, the present disclosure provides a shared electric bike with integrated frame and lamps to address issues such as the susceptibility of lamp holders to damage, which can affect illumination, and the potential risk of lamp theft.

The technical solution adopted to address the above-mentioned technical problem in the present disclosure is:

A shared electric bike with integrated frame and lamps, comprising:
a frame comprising a support tube, a handle connected at an end of the support tube, a first frame tube securely connected to the support tube, and a second frame tube, wherein a front lamp is embedded in one end of the first frame tube, the other end of the first frame tube is securely connected to one end of the second frame tube, and the other end of the second frame tube is securely connected to a seat tube, and wherein a rear lamp is embedded in an end of the seat tube;
a set of wheels comprising a front wheel and a rear wheel, wherein the support tube is provided with a connecting arm connected to an axle of the front wheel, and the second frame tube is provided with a connecting tube connected to an axle of the rear wheel; and
a battery, wherein the seat tube is provided with a mounting base for receiving the battery.

According to one or more embodiments, the connecting tube is provided with a limiting groove, in which the axle of the rear wheel is engaged and secured by a second nut.

According to one or more embodiments, the connecting tube is provided with a clamping groove proximal to the limiting groove, and wherein a footboard is mounted in the clamping groove, and a protective shell securely connects the footboard to the connecting tube.

According to one or more embodiments, the connecting arm is provided with a groove, in which the axle of the front wheel is engaged and secured by a first nut, and wherein the connecting arm is provided with a first mudguard.

According to one or more embodiments, the seat tube is securely connected to a second mudguard at its bottom part, and wherein both sides of the second mudguard are provided with a reinforcing tube for connecting the seat tube with the connecting tube.

According to one or more embodiments, the second frame tube is provided with two connecting tubes connected to an axle of the rear wheel, and wherein a reinforcing block between the two connecting tubes is securely connected to the second mudguard.

According to one or more embodiments, the seat tube is provided with a U-shaped rear support structure.

According to one or more embodiments, a bike seat is arranged above the mounting base.

According to one or more embodiments, the connecting tube is provided with a kickstand to provide support.

The beneficial effects of the present disclosure are as follows:

A shared electric bike with integrated frame and lamps is provided, wherein the front lamp is embedded in the first frame tube, and the rear lamp is embedded in the seat tube, eliminating the need for lamp holders, such that an integrated configuration of frame and lamps is achieved, enhancing the overall aesthetics. Furthermore, the integrated configuration of frame and lamps resolves issues associated with mounting lamps on the frame through lamps holders, such as the susceptibility of lamps holders to damage, affecting illumination, and the potential risk of lamp theft.

### BRIEF DESCRIPTION OF THE DRAWINGS

The present disclosure will be further described below with the accompanying drawings and examples.

FIG. 1 illustrates a schematic structural diagram of a shared electric bike according to one or more embodiments of the present disclosure.

FIG. 2 illustrates a side view of the shared electric bike as shown in FIG. 1.

FIG. 3 illustrates a schematic structural diagram of the components located at the rear wheel of the shared electric bike as shown in FIG. 1.

FIG. 4 illustrates a schematic structural diagram of a connecting arm of the shared electric bike as shown in FIG. 1.

### DETAILED DESCRIPTION

The following will be a clear and complete description of the conception, specific structure and technical effects produced by the present disclosure with the embodiments and the accompanying drawings, in order to fully understand the purpose, features and effects of the present disclosure. Obviously, the described embodiments are only part but not all of the embodiments of the present disclosure, and based on the embodiments of the present disclosure, other embodiments obtainable by a person skilled in the art without creative labor fall within the protection scope of the present disclosure. In addition, all the coupling/connection relationships involved in this disclosure do not refer to the direct connection between the members alone, but to the fact that a better coupling structure can be composed by adding or reducing coupling auxiliary parts according to the specific implementation. The various technical features of the disclosure can be interactively combined without contradicting each other.

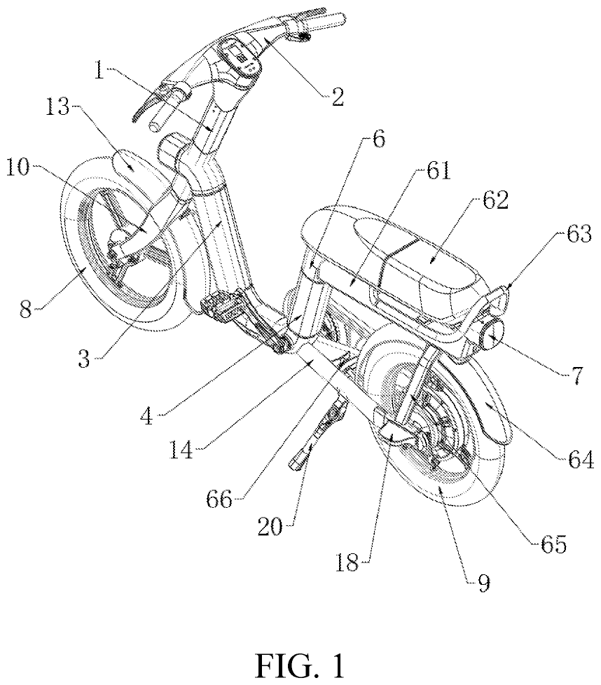

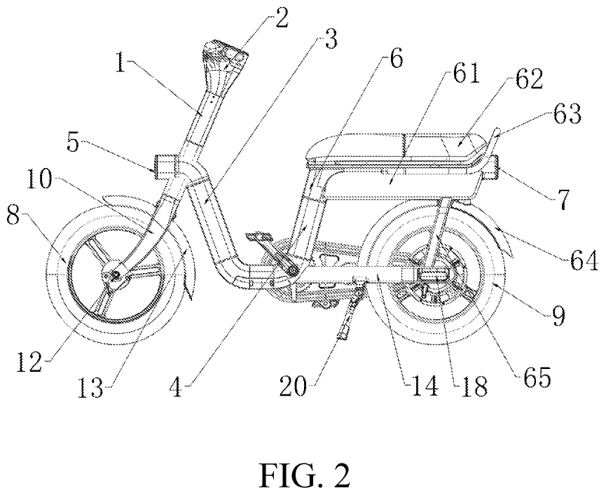

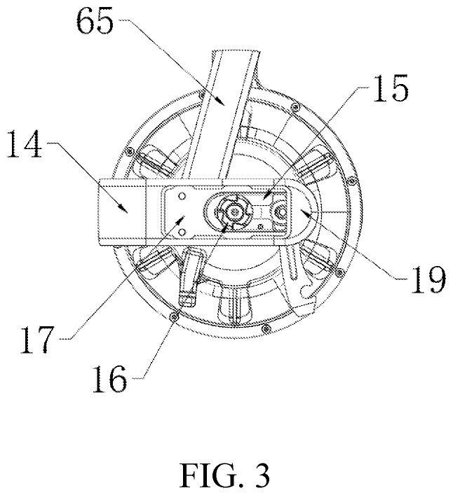

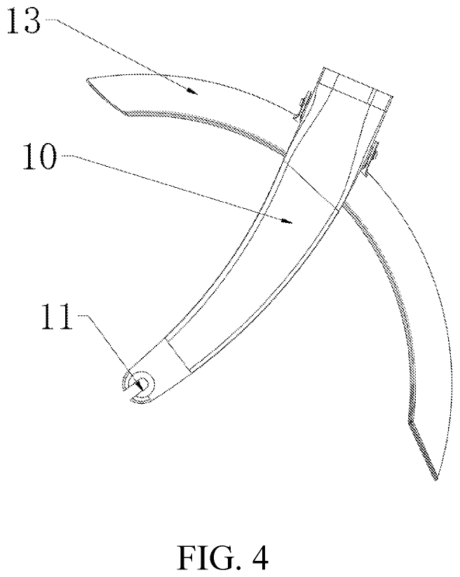

With reference to FIGS. 1-4, one or more embodiments of the present disclosure provide a shared electric bike with integrated frame and lamps, comprising a frame, a set of wheels, and a battery. The frame comprises a support tube 1, a handle 2 connected at one end of the support tube 1, a first frame tube 3, and a second frame tube 4, wherein the first frame tube 3 is securely connected to the support tube 1. According to one or more embodiments, the first frame tube 3 is welded to the second frame tube 4, and the first frame tube 3 is welded to the support tube 1. A front lamp 5 is embedded in one end of the first frame tube 3, the other end of the first frame tube 3 is securely connected to one end of the second frame tube 4, and the other end of the second frame tube 4 is securely connected to a seat tube 6. A rear lamp 7 is embedded in one end of the seat tube 6, and the seat tube 6 is provided with a mounting base 61 for receiving the battery. A bike seat 62 is arranged above the mounting base 61. The seat tube 6 is provided with a U-shaped rear support structure 63. In accordance with one or more embodiments, the first frame tube 3, the second frame tube 4, and the support tube 1 are integrally die-cast for enhanced structural stability through welding, and the front lamp 5 and the rear lamp 7 are embedded in the first frame tube 3 and the seat tube 6, respectively. This integration of the electric bike enhances overall safety, making it less susceptible to damage. Furthermore, it prevents potential issues such as damage to the lamps and reduces the risk of lamp theft.

The set of wheels includes a front wheel 8 and a rear wheel 9. The support tube 1 has a connecting arm 10 connected to an axle of the front wheel 8. The connecting arm 10 features a groove 11, in which the axle of the front wheel 8 is engaged and secured by a first nut 12. According to one or more embodiments, the connecting arm 10 is provided with a first mudguard 13. The second frame tube 4 is provided with a connecting tube 14 connected to an axle of the rear wheel 9. The seat tube 6 is securely connected to a second mudguard 64 at its bottom part. Both sides of the second mudguard 64 are provided with a reinforcing tube 65 for connecting the seat tube 6 with the connecting tube 14. According to one or more embodiments, the second frame tube 4 is provided with two connecting tubes 14 connected to an axle of the rear wheel 9, between which a reinforcing block 66 is securely connected to the second mudguard 64. According to one or more embodiments, the connecting tube 14 is provided with a limiting groove 15, in which the axle of the rear wheel 9 is engaged and secured by a second nut 16. The connecting tube 14 is provided with a clamping groove 17 proximal to the limiting groove 15, wherein a footboard 18 is mounted in the clamping groove 17. According to one or more embodiments, the footboard 18 is an aluminum alloy die-cast component. According to one or more embodiments, the footboard 18 serves as a protective plate, positioned on the outer side of the axle of the rear wheel to cover the second nut 16, and a protective shell 19 securely connects the footboard 18 to the connecting tube 14, such that the footboard 18 is integrated with the entire bike, making it less susceptible to damage. According to one or more embodiments, the connecting tube 14 is provided with a kickstand 20 to provide support.

FIGS. 1 through 4 illustrate examples, where reference numeral 1 is a support tube, 2 is a handle, 3 is a first frame tube, 4 is a second frame tube, 5 is a front lamp, 6 is a seat tube, 7 is a rear lamp, 8 is a front wheel, 9 is a rear wheel, 10 is a connecting arm, 11 is a groove, 12 is a first nut, 13 is a first mudguard, 14 is a connecting tube, 15 is a limiting groove, 16 is a second nut, 17 is a clamping groove, 18 is a footboard, 19 is a protective shell, 20 is a kickstand, 61 is a mounting base, 62 is a bike seat, 63 is a rear support structure, 64 is a second mudguard, 65 is a reinforcing tube, and 66 is a reinforcing block.

The above merely describes specific embodiments of the present disclosure, which is not intended to limit the scope of protection of the present disclosure. Any modifications, equivalent variations or substitutions, and improvements made within the spirit and principle of the present disclosure by those skilled in the art according to the disclosed technical scope should be included in the protection scope of the present disclosure.

What is claimed is:

1. A shared electric bike with integrated frame and lamps, comprising:
a frame comprising a support tube, a handle connected at an end of the support tube, a first frame tube securely connected to the support tube, and a second frame tube, wherein a front lamp is embedded in one end of the first frame tube, the other end of the first frame tube is securely connected to one end of the second frame tube, and the other end of the second frame tube is securely connected to a seat tube, and wherein a rear lamp is embedded in an end of the seat tube;
a set of wheels comprising a front wheel and a rear wheel, wherein the support tube is provided with a connecting arm connected to an axle of the front wheel, and the second frame tube is provided with a connecting tube connected to an axle of the rear wheel; and
a battery, wherein the seat tube is provided with a mounting base for receiving the battery.

2. The shared electric bike according to claim 1, wherein the connecting tube is provided with a limiting groove, in which the axle of the rear wheel is engaged and secured by a second nut.

3. The shared electric bike according to claim 2, wherein the connecting tube is provided with a clamping groove proximal to the limiting groove, and wherein a footboard is mounted in the clamping groove, and a protective shell securely connects the footboard to the connecting tube.

4. The shared electric bike according to claim 1, wherein the connecting arm is provided with a groove, in which the axle of the front wheel is engaged and secured by a first nut, and wherein the connecting arm is provided with a first mudguard.

5. The shared electric bike according to claim 1, wherein the seat tube is securely connected to a second mudguard at its bottom part, and wherein both sides of the second mudguard are provided with a reinforcing tube for connecting the seat tube with the connecting tube.

6. The shared electric bike according to claim 5, wherein the second frame tube is provided with two connecting tubes connected to an axle of the rear wheel, and wherein a reinforcing block between the two connecting tubes is securely connected to the second mudguard.

7. The shared electric bike according to claim 5, wherein the seat tube is provided with a U-shaped rear support structure.

8. The shared electric bike according to claim 1, wherein a bike seat is arranged above the mounting base.

9. The shared electric bike according to claim 1, wherein the connecting tube is provided with a kickstand to provide support.
